(19) United States
(12) Patent Application Publication
(10) Pub. No.: US 2005/0086396 A1
(43) Pub. Date: Apr. 21, 2005

(54) Communication system

(76) Inventors: Francois Bernard, Belbeuf (FR); Frederic Dutulleul, Le Neubourg (FR)

Correspondence Address: PHILIPS INTELLECTUAL PROPERTY & STANDARDS, P.O. BOX 3001, BRIARCLIFF MANOR, NY, 10510, US

(21) Appl. No.: 10/499,939

(22) PCT Filed: Dec. 20, 2002
(86) PCT No.: PCT/IB02/05682

(30) Foreign Application Priority Data
Dec. 28, 2001 (EP) 01403380.7

(51) Int. Cl. G06F 13/42

(52) U.S. Cl. 710/3

(57) ABSTRACT

The invention relates to a communication system comprising a control unit (100), a plurality of circuits (101-104) intended to be accessed by the control unit and a bus (105) intended to allow a data exchange between the control unit and an accessed circuit. In order to avoid that the circuits have specific address, they are accessed by the control unit in a predefined accessing order, and the system comprises means for changing an address of a circuit so that an accessed circuit has a predefined address. The circuits having no specific addresses, such a communication system is particularly easy to create or modify. The invention is particularly relevant for a dispatching station for TV signals.

### FIELD OF THE INVENTION

The present invention relates to a communication system comprising at least a control unit, a plurality of circuits intended to be accessed by the control unit and having addresses and a bus intended to allow a data exchange between the control unit and an accessed circuit among the plurality of circuits. The present invention is particularly relevant for a dispatching station for TV signals.

### BACKGROUND OF THE INVENTION

Such a communication system is described in “the I²C-bus specification” published by Philips Semiconductors in January 2000.

In such a communication system, a control unit communicates with circuits, which can operate as transmitters or receivers. In order to communicate with a given circuit, the control unit accesses this given circuit by sending an I²C-frame via the I²C-bus, said I²C-frame specifying an address of the given circuit.

A drawback of such a communication system lies in the fact that each circuit connected to the bus must have a specific address, which has to be software programmed or hardware defined. This makes a creation or a modification of such a communication system difficult, because a step of giving specific addresses to the circuits is necessary.

### SUMMARY OF THE INVENTION

It is an object of the invention to provide a communication system, which can be created and modified more easily.

To this end, a communication system according to the invention and as described in the opening paragraph is characterized in that it comprises changing means for changing an address of a circuit and the circuits are accessed by the control unit in a predefined accessing order, an accessed circuit having a predefined address allocated to it by said changing means.

According to the invention, the circuits do not need any specific address. A creation and modification of the system are therefore easy, because they do not need any step of giving specific addresses to the circuits.

Furthermore, a frame indicating the address of the circuit accessed by the control unit is the same, irrespective of the circuit accessed. Actually, only three addresses can define the different accessing states: a first address for a circuit not yet accessed, a second address for the circuit currently accessed and a third address for a circuit already accessed. Moreover, as only three addresses have to be defined, these addresses can be coded in two bits.

In a first embodiment, the changing means comprise at least an accessing wire connecting a first circuit in the accessing order to the control unit and at least one sequencing wire connecting two consecutives circuits in the accessing order.

According to this embodiment, wires connecting two circuits are only required to define the accessing order, which makes such a communication system particularly easy to design.

Preferably, the circuits comprise an addressing module having at least two addressing inputs and at least one data output, a change of a value of the data output of a given addressing module providing changes of the values of at least one of its addressing inputs and at least one of the addressing inputs of the addressing module of the next circuit in the accessing order.

In this way, a simple change of the value of a data output at the end of a communication between the control unit and an accessed circuit causes a modification of the addresses of the accessed circuit and of the next circuit in the accessing order, said next circuit being then able to be accessed by the control unit.

In a second embodiment, a circuit further comprises at least a device controlled by a switch, said switch being closed when said circuit is accessed. According to this embodiment, data can be written in or read from a device of a circuit, only when the control unit accesses this circuit.

In a third embodiment, the addressing module comprises means for generating a switch bit intended to control said switch, said means for generating a switch bit being controlled by the control unit.

These and other aspects of the invention will be apparent from and elucidated with reference to the embodiments described hereinafter.

### BRIEF DESCRIPTION OF THE DRAWINGS

The invention will now be described in more detail by way of example with reference to the accompanying drawings, in which:

FIG. 1 shows a communication system in accordance with the invention;

FIG. 2 shows in detail a control unit, a first and a third circuit and a bus of the communication system of FIG. 1;

FIG. 3 shows a communication system in accordance with the invention, implementing an I²C-bus;

FIG. 4 shows an embodiment of an addressing module of a circuit of the communication system of FIG. 3;

### DESCRIPTION OF AT LEAST ONE PREFERRED EMBODIMENT OF THE INVENTION

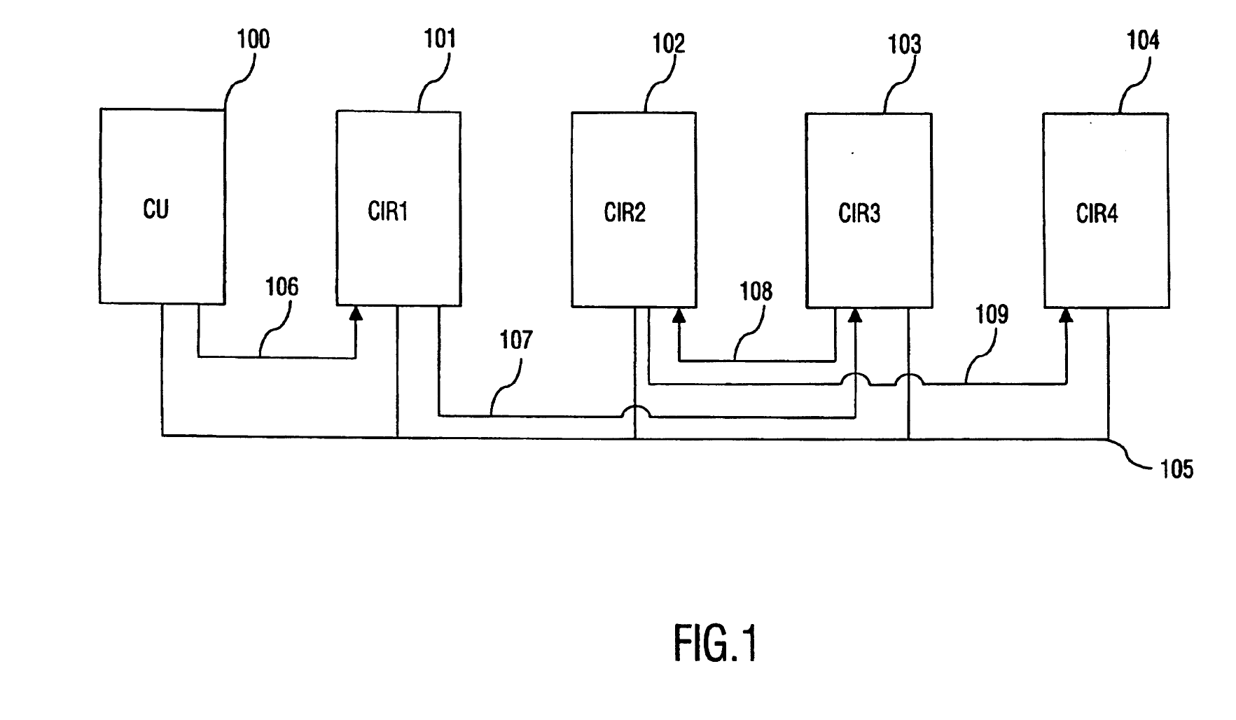

A communication system according to the invention is depicted in FIG. 1. Such a communication system comprises a control unit 100, a first circuit 101, a second circuit 102, a third circuit 103, a fourth circuit 104, a bus 105, an accessing wire 106, a first sequencing wire 107, a second sequencing wire 108 and a third sequencing wire 109.

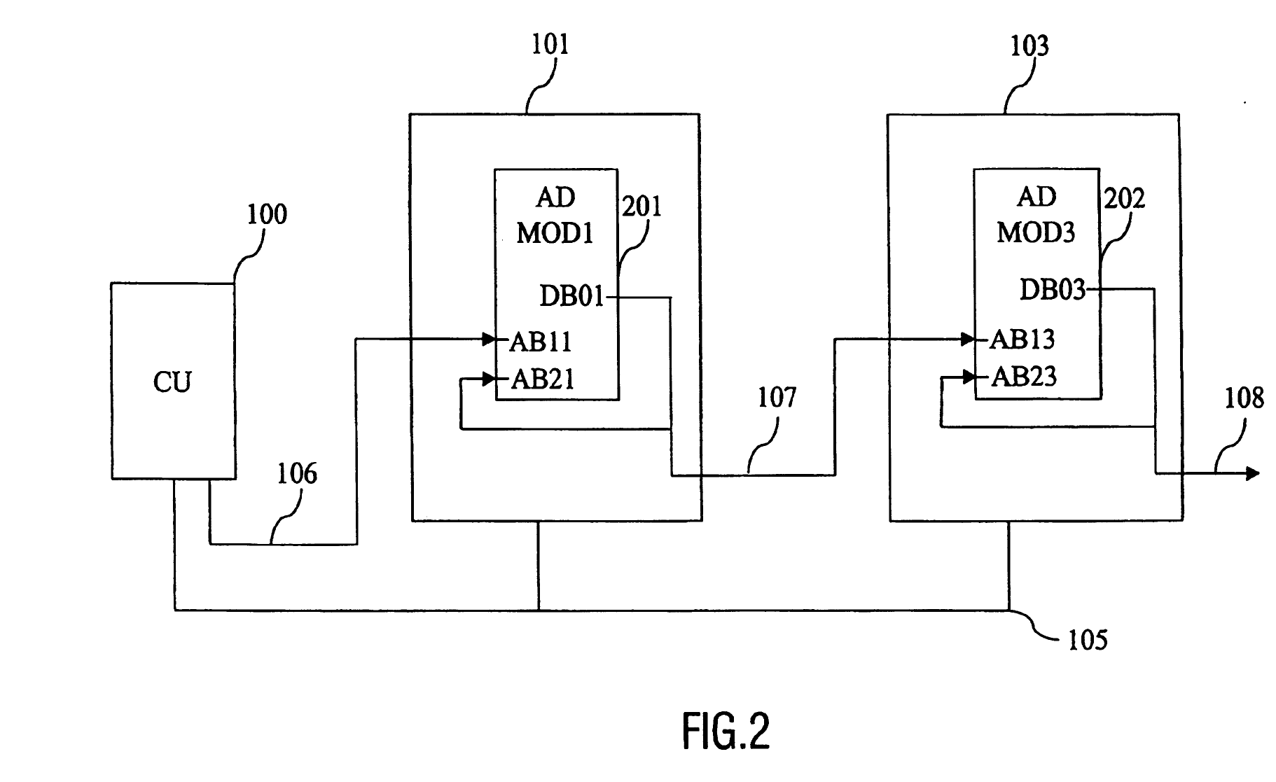

In such a communication system, the four circuits 101 to 104 do not have any specific address, but they are accessed by the control unit 100 in the following manner. The control unit 100 sends an accessing signal on the accessing wire 106 to access the first circuit 101. This accessing signal will be described in detail in the description of FIG. 2. Once the first circuit 101 is accessed, the control unit 100 reads a first identifier loaded in a memory of the first circuit 101. The control unit 100 has access to a database comprising properties of a circuit having a given identifier. These properties can be, for example, a list of modules comprised in this circuit, and a way to communicate with such modules. This database can be loaded, for example, in a memory of the control unit 100.

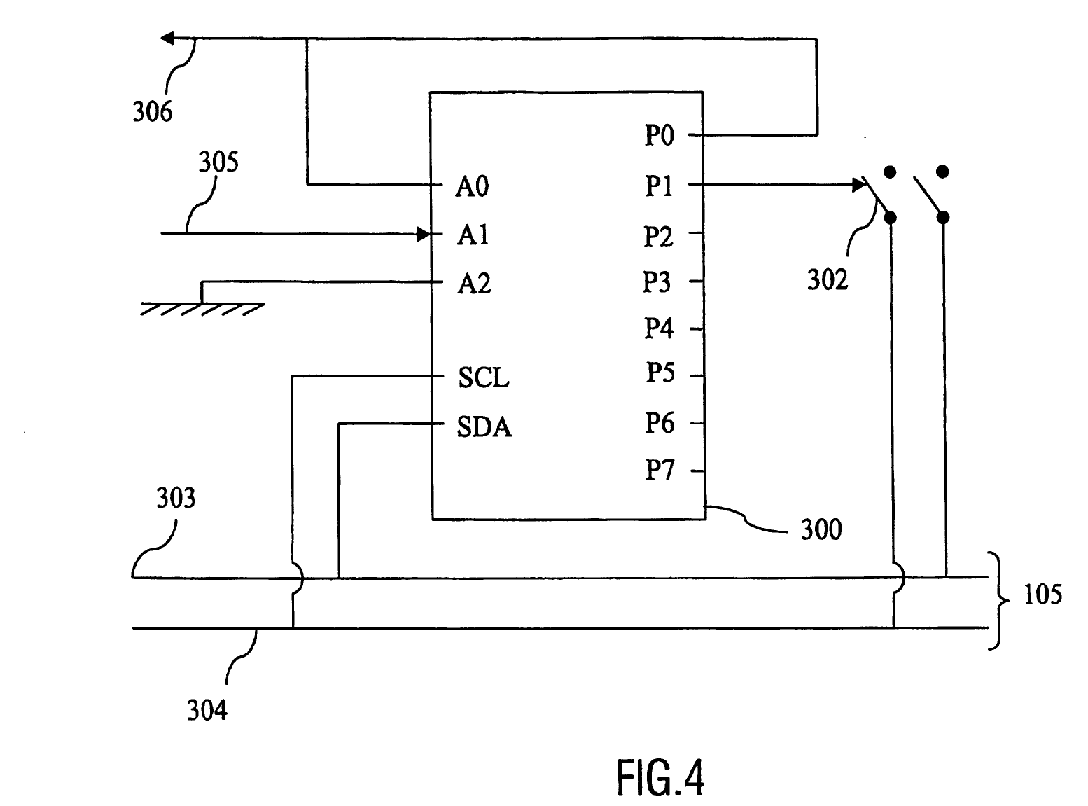

At the end of a communication between the control unit 100 and the first circuit 101, the control unit 100 sends a first stop signal to the first circuit 101 on the bus 105. Such a stop signal will be described in detail in the description of FIG. 4. This first stop signal generates a first sequencing signal on the first sequencing wire 107, which has the effect of making the third circuit 103 accessible to the control unit 100. The control unit 100 then reads a second identifier loaded in a memory of the third circuit 103, and can therefore communicate with one or more modules of the third circuit 103.

At the end of a communication between the control unit 100 and the third circuit 103, the control unit 100 sends a second stop signal to the third circuit 103 on the bus 105. As has been described hereinbefore, this has the effect of making the second circuit 102 accessible to the control unit 100.

Following a similar procedure, the second circuit 102 is then accessed by the control unit 100, a third identifier is read and the control unit 100 communicates with the second circuit 102 and, finally, the fourth circuit 104 is accessed, a fourth identifier is read and the control unit 100 communicates with the fourth circuit 104.

Suppose that the third circuit 103 is replaced by a replacement circuit. This replacement circuit will be accessed by the control unit 100 after the first circuit 101, because the accessing order is only defined by the accessing wire 106 and the sequencing wires 107, 108 and 109. The control unit will read an identifier in a memory of this replacement circuit, and will thus be able to communicate with it. Consequently, the replacement circuit does not need any specific address. Therefore, a modification of the communication system according to the invention is particularly easy, because such a modification does not need any step of giving a specific address to a replacement circuit.

FIG. 2 shows in detail a communication between the control unit 100, the first circuit 101 and the third circuit 103. The first circuit 101 comprises a first addressing module 201 and the third circuit 103 comprises a second addressing module 202. The first addressing module 201 has a first addressing input AB1, a second addressing input AB21 and a first data output DB01. The second addressing module 202 has a third addressing input AB13, a fourth addressing input AB23 and a second data output DBO3.

When the control unit 100 has not accessed any circuit on the bus 105, the addressing inputs AB11, AB21, AB13 and AB23, and the data outputs DB01 and DBO3, have the value 0. The control unit 100 sends an accessing signal on the accessing wire 106, said accessing signal being, for example, a pulse, which has the effect of giving the value 1 to the first addressing input AB11. Then the control unit 100 accesses the circuit on the bus 105 which addressing module has its addressing inputs set to 1 and 0, that is to say, in this case, the first circuit 101. When a communication between the control unit 100 and the first circuit 101 is finished, for example when the control unit 100 has read an identifier in a memory of the first circuit 101, the control unit 100 sends a stop signal on the bus 105, which has the effect of giving the value 1 to the first data output DB01. This has thus the effect of giving the value 1 to the second addressing input AB21 and the value 1 to the third addressing input AB13.

Then the control unit 101 continues to access the circuit on the bus 105, which addressing module has its addressing inputs set to 1 and 0, that is to say, in this case, the third circuit 103. Actually, the first addressing module 201 has now its addressing inputs set to 1 and 1. When a communication between the control unit 100 and the third circuit 103 is finished, for example when the control unit 100 has finished writing data, via the bus 105, in a module of the third circuit 103, the control unit 100 sends a stop signal on the bus 105, which has the effect of giving the value 1 to the second data output DB03. This has thus the effect of giving the value 1 to the fourth addressing input AB23 and the value 1 to an addressing input of the next circuit in the accessing order.

Let us assume that there is no other circuit on the bus 105, that is to say, that the third circuit 103 is the last circuit in the accessing order. In this case, when the control unit 100 has sent the stop signal on the bus 105, it sends another accessing signal on the accessing wire 106, which has the effect of giving the value 0 to the first addressing input AB11. Then the control unit 100 accesses the circuit on the bus 105, which addressing module has its addressing inputs set to 0 and 1, that is to say, the first circuit 101, and, when a communication with this circuit has finished, the control unit 100 sends a stop signal on the bus 105, which has the effect of giving the value 0 to the first data output DB01. The control unit can therefore access the third circuit 103, by accessing the circuit on the bus 105, which addressing module has its addressing inputs set to 0 and 1.

Another solution to accessing the first circuit in the accessing order, that is to say, the first circuit 101, comprises reinitializing all the values of the addressing inputs of the addressing modules of all the circuits present on the bus 105, that is to say, giving these addressing inputs the value 0. In order to effect such a reinitialization, the control unit 100 accesses all circuits on the bus 105 which addressing modules have their addressing inputs set to 1 and 1, that is to say, in this case, the first circuit 101 and the third circuit 103, and sends a signal on the bus 105, which has the effect of giving the value 0 to the data outputs of the addressing modules of all accessed circuits. Consequently, the addressing inputs of the addressing modules of all the circuits present on the bus 105 receive the value 0. Then, the control unit 100 can access the first circuit 101 by sending an accessing signal on the accessing wire 106, said accessing signal having the effect of giving the value 1 to the first addressing input AB11.

It is important to note that the control unit 100 does not “know” which circuit on the bus 105 is the last circuit in the accessing order. Suppose that in this example, the third circuit 103 is the last circuit in the accessing order, which means that the second sequencing wire 108 does not exist. At the end of a communication between the control unit 100 and the third circuit 103, the control unit 100 sends a stop signal on the bus 105, which has the effect of giving the value 1 to the second data output DB03. The control unit then tries to read an identifier in a memory of a circuit which addressing module has its addressing inputs set to 1 and 0. As no addressing module has its addressing inputs set to 1 and 0, such a reading is impossible, which indicates to the control unit 100 that the third circuit 103 is the last circuit in the accessing order.

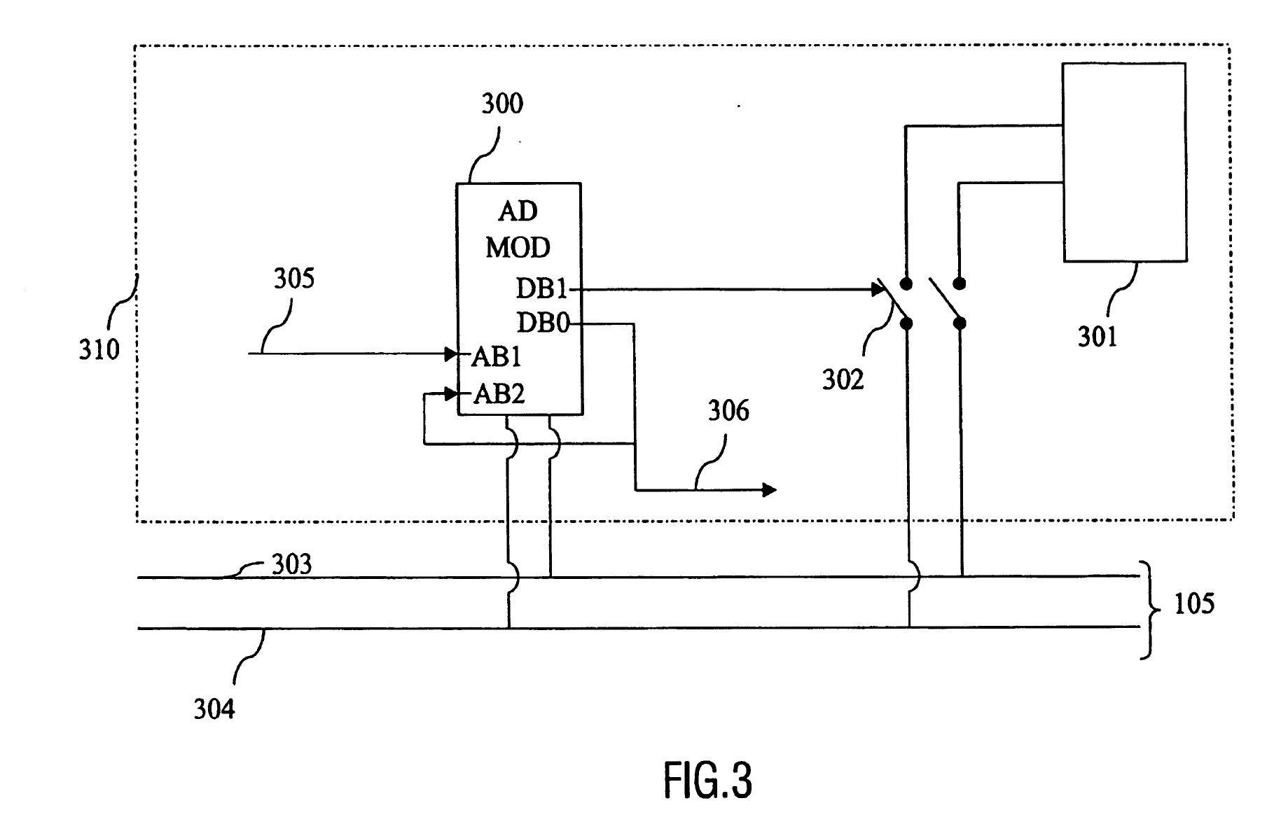

FIG. 3 shows a circuit 310 according to the invention, said circuit being connected to the bus 105, which is, in this case, an I²C-bus. The circuit 310 comprises an addressing module 300, a device 301 and two switches 302. The addressing module 300 has a first addressing input AB1, a second addressing input AB2, a data output DBO and a switch output DB1. The circuit 310 can be, for example, the first circuit 101 of FIG. 2. In such a case, the first and second addressing inputs AB1 and AB2 are the first and second addressing inputs AB11 and AB21 of FIG. 2. The circuit 310 can also be the third circuit 103 of FIG. 2. In such a case, the first and second addressing inputs AB1 and AB2 are the third and fourth addressing inputs AB13 and AB23 of FIG. 2. The bus 105 comprises a serial data wire 303 and a serial clock wire 304.

The circuit 310 comprises a command wire 305 and a sequencing wire 306. If the circuit 310 is the first circuit 101, the command wire 305 corresponds to the accessing wire 106 and the sequencing wire 306 to the first sequencing wire 107. If the circuit 310 is the third circuit 103, the command wire 305 corresponds to the first sequencing wire 107 and the sequencing wire 306 to the second sequencing wire 108.

When the circuit 310 has just been accessed, the two switches 302 are opened and the switch output DB1 has the value 0. The control unit sends an I²C frame on the serial data wire 303, which has the effect of giving the value 1 to the switch output DB1 and thus closing the two switches 302 controlled by the value of the switch output DB1. Such an I²C frame comprises at least four bits indicating that an addressing module is accessed, these four bits depending only on a type of addressing module used according to the invention, and two bits indicating an address of the addressing module accessed, these two bits corresponding to the values of the first and second addressing inputs AB1 and AB2, which are, in this case, either 1 0 or 0 1, as it has been explained in the description of FIG. 2.

When the two switches 302 are closed, the control unit 100 can read or write data from or in the device 301. Its identifier identifies the circuit 310, as it has been described hereinbefore. The database to which the control unit 100 has access, as it has been described hereinbefore, can, for example, specify that the circuit 310 comprises an addressing module of a given type, and a device 301 comprising, for example, a first synthesizer having a first I²C address, a second synthesizer having a second I²C address and a modulator having a third I²C address.

Let us assume that the control unit 100 wants to write data in the first synthesizer. The control unit 100 sends an I²C frame on the serial data wire 303, said frame comprising at least four bits indicating that a synthesizer is accessed and four bits indicating that the first synthesizer is accessed. These eight bits correspond to the first I²C address of the first synthesizer. Suppose that another synthesizer, comprised in another circuit connected to the bus 105, has the same I²C address. In this case, only the first synthesizer of circuit 310 will be accessed, because the two switches 302 of circuit 310 are closed, whereas the switches of the other circuit are opened.

When a communication between the control unit 100 and the circuit 310 has finished, the control unit sends an I²C frame on the serial data wire 303, which has the effect of giving to the switch output DB1 the value 0 and thus opening the two switches 302.

FIG. 4 shows an example of addressing module 300, which can be used to implement the invention. Such an addressing module 300 is marketed by the applicant under reference PCF8574. The addressing module 300 has three addressing inputs A0 to A2, a serial clock input SCL, a serial data input SDA and eight data outputs P0 to P7.

The addressing inputs A0 and A1 correspond to the second addressing input AB2 and the first addressing input AB1 of FIG. 3 respectively. The data outputs P0 and P1 correspond to the data output DB0 and the switch output DB1 of FIG. 3 respectively. The addressing input A2 is set to 0. An I²C frame sent by the control unit 100 to such an addressing module 300 has the following structure, the bits of the frame being sent serially to the serial data input SDA on the serial data wire 303:

| | | | | | | | | | | | | | | | | | | | |
|---|---|---|---|---|---|---|---|---|---|---|---|---|---|---|---|---|---|---|---|
| S | 0 | 1 | 0 | 0 | A2 | A1 | A0 | 0 | R/W | A | P0 | P1 | P2 | P3 | P4 | P5 | P6 | P7 | P |

S is a start bit;
“0 1 0 0” is a fixed part of the I²C address of a PCF8574 module;
“A2 A1 A0 0” is a variable part specifying which addressing module 300 on the bus 105 is accessed;
R/W is a bit indicating if a “read” or a “write” operation is required, for example R/W is equal to 1 for a write operation and to 0 for a read operation;
A is an acknowledgment bit;
“P0 P1 P2 P3 P4 P5 P6 P7” are the data to be written in or read from the addressing module 300;
P is a stop bit.

The following frame is an example of a stop signal sent by the control unit 100 at the end of a communication with the circuit 310:

| | | | | | | | | | | | | | | | | | | | |
|---|---|---|---|---|---|---|---|---|---|---|---|---|---|---|---|---|---|---|---|
| S | 0 | 1 | 0 | 0 | 0 | 1 | 0 | 0 | 1 | A | 1 | 0 | P2 | P3 | P4 | P5 | P6 | P7 | P |

When receiving this frame, the addressing module 300 having its addressing inputs A1 and A0 set to 1 and 0 gives the value 1 to its data output P0 and the value 0 to its data output P1. As it has been described hereinbefore, this has the effect of making the next circuit in the accessing order accessible to the control unit 100, and opening the two switches 302.

1. A communication system comprising at least:
a control unit (100);
a plurality of circuits (101-104) intended to be accessed by the control unit and having addresses;
a bus (105) intended to allow a data exchange between the control unit and an accessed circuit among the plurality of circuits said communication system being further characterized in that it comprises changing means for changing an address of a circuit and the circuits are accessed by the control unit in a predefined accessing order, an accessed circuit having a predefined address allocated to it by said changing means.

2. A communication system as claimed in claim 1, wherein said changing means comprise at least an accessing wire (106) connecting a first circuit in the accessing order to the control unit and at least one sequencing wire (107-109) connecting two consecutives circuits in the accessing order.

3. A communication system as claimed in claim 3, wherein said circuits comprise an addressing module (201-202) comprising at least two addressing inputs and at least one data output, a change of a value of the data output of a given addressing module providing changes of the values of at least one of its addressing inputs and at least one of the addressing inputs of the addressing module of the next circuit in the accessing order.

4. A communication system as claimed in claim 1, wherein a circuit further comprises at least a device (301) controlled by a switch (302), said switch being closed when said circuit is accessed.

5. A communication system as claimed in claim 4, wherein the addressing module comprises means for generating a switch bit intended to control said switch, said means for generating a switch bit being controlled by the control unit.
